(19) United States
(12) Patent Application Publication
(10) Pub. No.: US 2010/0139950 A1
(43) Pub. Date: Jun. 10, 2010

(54) SUPPORTING AND WIRE-RECEIVING MECHANISM OF POWER ADAPTER

(75) Inventor: YUAN-CHIN CHEN, Taipei Hsien (TW)

Correspondence Address: WPAT, PC;INTELLECTUAL PROPERTY ATTORNEYS, 7225 BEVERLY ST., ANNANDALE, VA, 22003, US

(73) Assignee: COOLER MASTER CO., LTD., Taipei Hsien (TW)

(21) Appl. No.: 12/478,992

(22) Filed: Jun. 5, 2009

(30) Foreign Application Priority Data
Dec. 5, 2008 (TW) 097221847

(51) Int. Cl. H01B 7/00; H01R 13/72

(52) U.S. Cl. 174/135; 439/501

(57) ABSTRACT

A supporting and wire-receiving mechanism is used in a power adapter. The power adapter includes a main body and a power wire. The supporting and wire-receiving mechanism includes a supporting member, a base and a wire-receiving member. The supporting member has a supporting receptacle for accommodating a main body of the power adapter, thereby supporting the power adapter. The base is arranged beside the supporting member. The wire-receiving member is arranged between the base and the supporting member such that a wire-receiving receptacle is defined between the wire-receiving member, the base and the supporting member. Both ends of the wire-receiving member are respectively connected with the base and the supporting member. The power wire is wound around the wire-receiving member and received in the wire-receiving receptacle.

### FIELD OF THE INVENTION

The present invention relates to a wire-receiving mechanism, and more particularly to a supporting and wire-receiving mechanism of a power adapter.

### BACKGROUND OF THE INVENTION

A power adapter used for a computer system has two power wires respectively protruded from both ends thereof. During operation of the computer system, one of the two power wires is connected to the computer host and the other of the two power wires is plugged into a power socket.

In practice, the power adapter has some drawbacks. For example, if the computer host is very close to the power socket, the power wires protruded from both ends of the power adapter are usually placed on the floor because the power wires are too long. For managing the power wires, the user may wind the power wires around the main body of the power adapter. Since the main body of the power adapter has no wire-fastening structure for fixing the wound wires, the power wires around the main body of the power adapter are readily loosened. On the other hand, if the too long power wires are directly placed on the floor without any managing measure, the power wires are possibly suppressed by chair legs or desk legs such that the power wires are damaged. In addition, the long power wires may cause stumble of the user or induce other using risks.

Therefore, there is a need of providing a supporting and wire-receiving mechanism so as to obviate the drawbacks encountered from the prior art.

### SUMMARY OF THE INVENTION

It is an object of the present invention to provide a supporting and wire-receiving mechanism of a power adapter, in which the supporting and wire-receiving mechanism has a supporting member to support the power adapter and a wire-receiving member to receive the wound power wire.

In accordance with an aspect of the present invention, there is provided a supporting and wire-receiving mechanism of a power adapter. The power adapter includes a main body and a power wire. The supporting and wire-receiving mechanism includes a supporting member, a base and a wire-receiving member. The supporting member has a supporting receptacle for accommodating a main body of the power adapter, thereby supporting the power adapter. The base is arranged beside the supporting member. The wire-receiving member is arranged between the base and the supporting member such that a wire-receiving receptacle is defined between the wire-receiving member, the base and the supporting member. Both ends of the wire-receiving member are respectively connected with the base and the supporting member. The power wire is wound around the wire-receiving member and received in the wire-receiving receptacle.

In accordance with another aspect of the present invention, there is provided a supporting and wire-receiving mechanism of a power adapter. The power adapter includes a main body and a power wire. The supporting and wire-receiving mechanism includes a supporting member and a base. The supporting member having a first surface and a second surface opposed to the first surface. A supporting receptacle is defined by the first surface of the supporting member for accommodating the main body of the power adapter. A wire-receiving member is disposed on a middle portion of the second surface of the supporting member. An outer periphery of the wire-receiving member has a smaller dimension than an outer periphery of the supporting member. The base is connected with the wire-receiving member for supporting the supporting the power adapter.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating the connection between a main body of a power adapter and a supporting and wire-receiving mechanism according to a first embodiment of the present invention;

FIG. 2 is a schematic exploded view illustrating the connection between a main body of a power adapter and a supporting and wire-receiving mechanism according to a second embodiment of the present invention;

FIG. 3 is a schematic assembled view illustrating the connection between a main body of a power adapter and a supporting and wire-receiving mechanism according to the first embodiment of the present invention;

FIG. 4 is a schematic assembled view of FIG. 3 that is taken from a different viewpoint;

FIG. 5 is a schematic assembled view of FIG. 3 that is taken along the line 5-5;

FIG. 6 is a schematic exploded view illustrating the connection between a main body of a power adapter and a supporting and wire-receiving mechanism according to a third embodiment of the present invention;

FIG. 7 is a schematic exploded view illustrating the connection between a main body of a power adapter and a supporting and wire-receiving mechanism according to a fourth embodiment of the present invention;

FIG. 8 is a schematic exploded view illustrating the connection between a main body of a power adapter and a supporting and wire-receiving mechanism according to a fifth embodiment of the present invention; and

FIG. 9 is a schematic exploded view illustrating the connection between a main body of a power adapter and a supporting and wire-receiving mechanism according to a sixth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

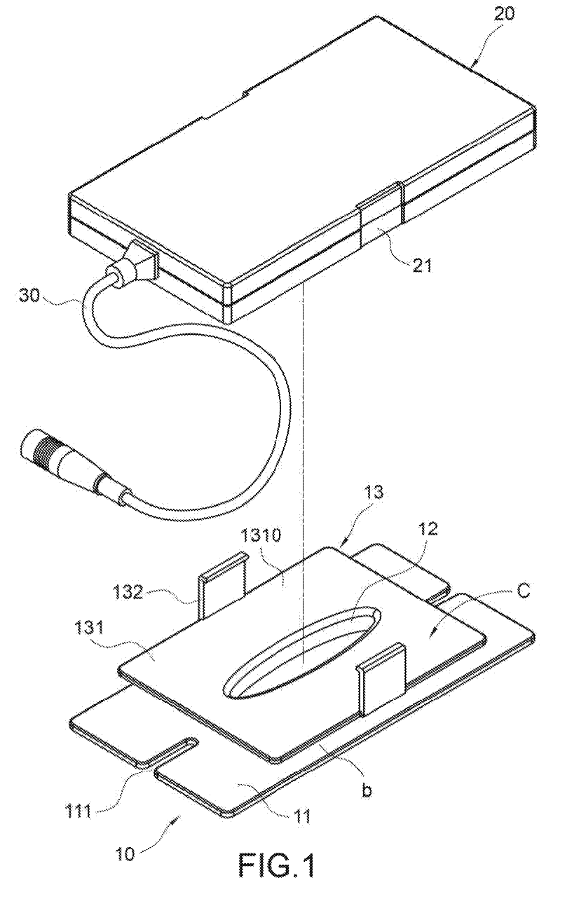

FIG. 1 is a schematic exploded view illustrating the connection between a main body of a power adapter and a supporting and wire-receiving mechanism according to a first embodiment of the present invention. The supporting and wire-receiving mechanism 10 is used for supporting a main body 20 of the power adapter and winding a power wire 30.

As shown in FIG. 1, the supporting and wire-receiving mechanism 10 includes a base 11, a supporting member 13 and a wire-receiving member 12.

The supporting member 13 has a supporting receptacle C for accommodating the main body 20 of the power adapter. The supporting member 13 includes an open-type supporting plate 131 and a set of hooking elements 132. The hooking elements 132 are respectively protruded from bilateral sides of the supporting plate 131. As shown in FIG. 1, the supporting receptacle C is collectively defined by a first surface 1310 of the supporting plate 131 and the hooking elements 132.

The base 11 is disposed beside the supporting member 13. An example of the base 11 includes but is not limited to a rectangular slab. In addition, the base 11 has a wire-locking recess 111 for locking the power wire 30.

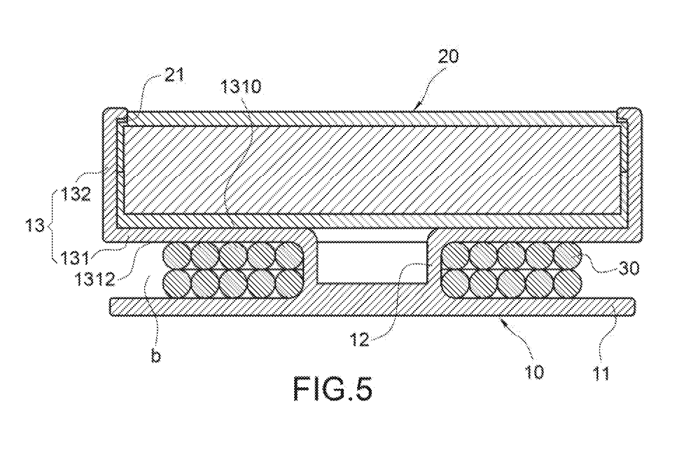

The wire-receiving member 12 is arranged between the base 11 and the supporting member 13. Both ends of the wire-receiving member 12 are respectively connected with the base 11 and the middle portion of a second surface 1312 of the supporting member 13 (see FIG. 5). The wire-receiving member 12 has an elliptic cross-section. It is of course that the wire-receiving member 12 can have any other cross-section. A wire-receiving receptacle b is defined between the outer periphery of the wire-receiving member 12, the base 11 and the supporting member 13. The power wire 30 is wound around the wire-receiving member 12 and accommodated within the wire-receiving receptacle b.

For defining the wire-receiving receptacle b, the dimension of the outer periphery of the wire-receiving member 12 is smaller than the dimension of the outer periphery of base and the dimension of the outer periphery of the supporting member 13.

In this embodiment, corresponding to the hooking elements 132 of the supporting member 13, the power adapter has two concave parts 21 former in two opposite long sides of the main body 20 of the power adapter. After the power adapter is accommodated within the supporting receptacle C, the hooking elements 132 are engaged with corresponding concave parts 21, so that the main body 20 of the power adapter is securely fixed on the supporting plate 131. Furthermore, when the hooking elements 132 are disengaged from corresponding concave parts 21, the main body 20 of the power adapter can be detached from the supporting member 13 without difficulty.

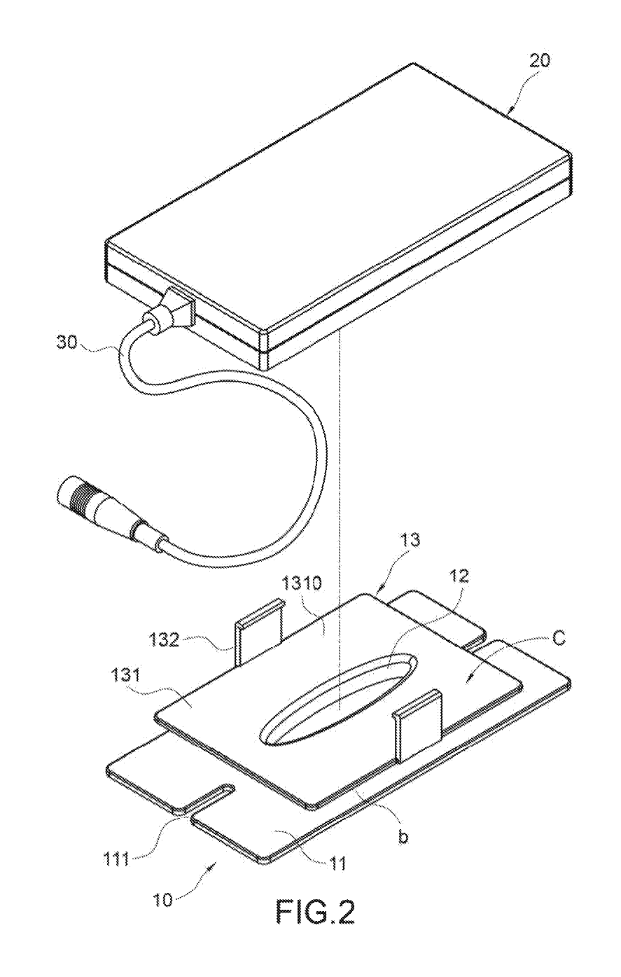

FIG. 2 is a schematic exploded view illustrating the connection between a main body of a power adapter and a supporting and wire-receiving mechanism according to a second embodiment of the present invention. The base 11, the supporting member 13 and the wire-receiving member 12 included in the supporting and wire-receiving mechanism 10 of FIG. 2 are identical to those shown in FIG. 1, and are not redundantly described herein. As shown in FIG. 2, the concave parts 21 are exempted from the main body 20 of the power adapter. After the power adapter is accommodated within the supporting receptacle C, the main body 20 of the power adapter is directly clamped by the hooking elements 132, so that the main body 20 of the power adapter is securely fixed on the supporting plate 131. Furthermore, when the hooking elements 132 are separated from the main body 20 of the power adapter, the main body 20 of the power adapter can be detached from the supporting member 13 without difficulty.

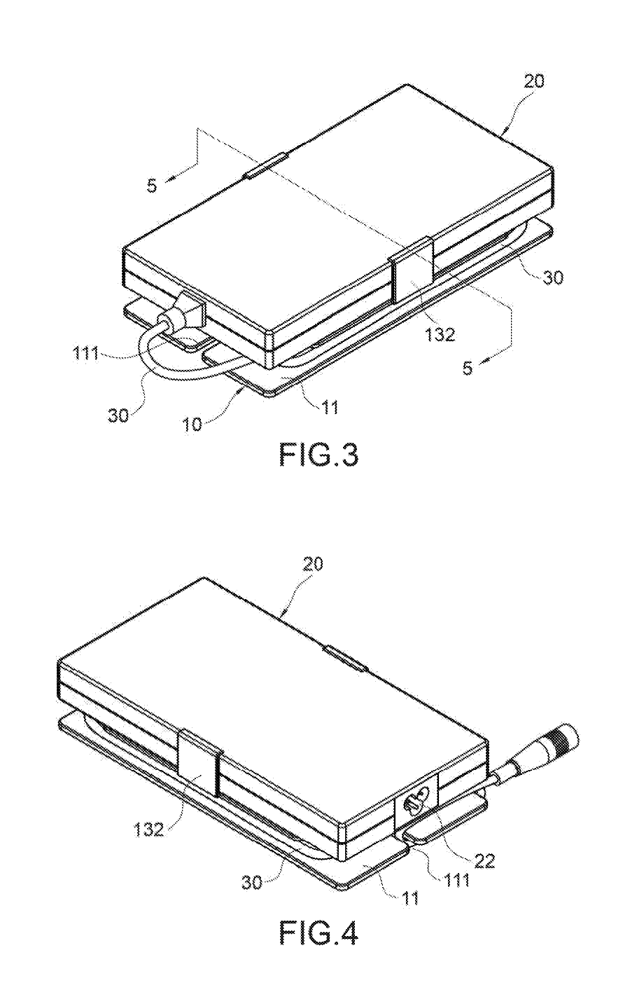

FIG. 3 is a schematic assembled view illustrating the connection between a main body of a power adapter and a supporting and wire-receiving mechanism according to the first embodiment of the present invention. FIG. 4 is a schematic assembled view of FIG. 3 that is taken from a different viewpoint. FIG. 5 is a schematic assembled view of FIG. 3 that is taken along the line 5-5. As shown in FIGS. 3, 4 and 5, the power wire 30 is wound around the wire-receiving member 12 and accommodated within the wire-receiving receptacle b. In a case that the power adapter is not in use, the terminal of the power wire 30 can be locked in the wire-locking recess 111. As a consequence, the problem of loosening the power wire 30 that is encountered from the prior art will be effectively solved.

Furthermore, since the main body 20 of the power adapter is supported on the supporting member 13 of the supporting and wire-receiving mechanism 10, the power adapter is no longer in direct contact with the floor. Under this circumstance, the possibility of causing damage of the power adapter is minimized because the dust or water accumulated on the floor is no longer detrimental to the power adapter.

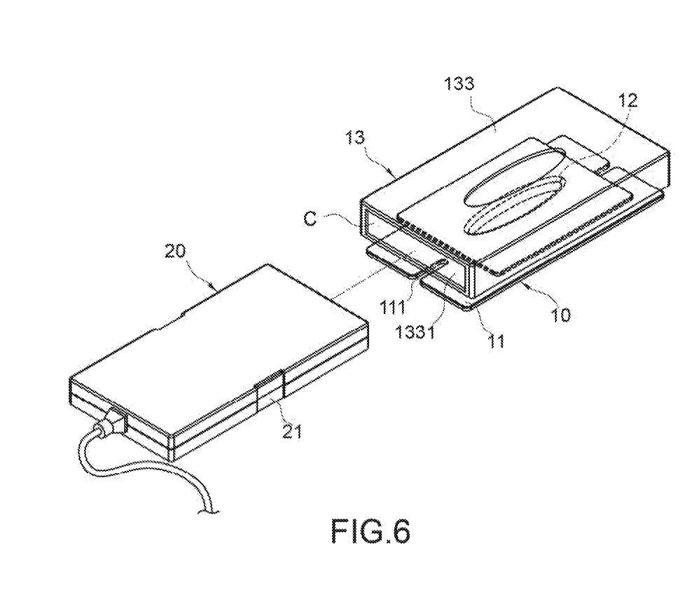

FIG. 6 is a schematic exploded view illustrating the connection between a main body of a power adapter and a supporting and wire-receiving mechanism according to a third embodiment of the present invention. The supporting and wire-receiving mechanism 10 of FIG. 6 also comprises a base 11, a supporting member 13 and a wire-receiving member 12. In this embodiment, the supporting member 13 includes a hollow box 133. The hollow box 133 has two entrances 1331, which are respectively disposed at two opposite sides of the hollow box 133. The main body 20 of the power adapter can be accommodated within the hollow box 133 through one of the entrances 1331. Similarly, both ends of the wire-receiving member 12 are respectively connected with the base 11 and the supporting member 13. A wire-receiving receptacle is defined between the outer periphery of the wire-receiving member 12, the base 11 and the supporting member 13. After the main body 20 of the power adapter is accommodated within the hollow box 133, the power wire can be wound around the wire-receiving member 12 and accommodated within the wire-receiving receptacle.

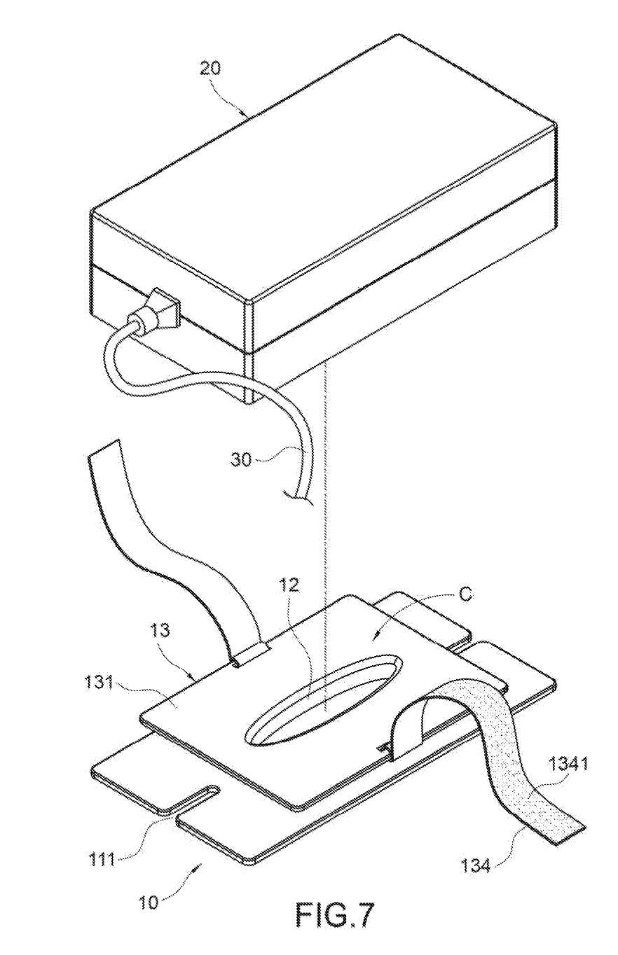

FIG. 7 is a schematic exploded view illustrating the connection between a main body of a power adapter and a supporting and wire-receiving mechanism according to a fourth embodiment of the present invention. The base 11 and the wire-receiving member 12 included in the supporting and wire-receiving mechanism 10 of FIG. 1 are identical to those shown in FIG. 1, and are not redundantly described herein. In this embodiment, the supporting member 13 includes an open-type supporting plate 131 and two straps 134. These two straps 134 are respectively connected with bilateral sides of the supporting plate 131. These two straps 134 have Velcro fasteners 1341 on corresponding surfaces thereof. After the power adapter is accommodated within the supporting receptacle C, the Velcro fasteners 1341 attached on these two straps 134 are engaged with each other, so that the main body 20 of the power adapter is securely fixed on the supporting plate 131.

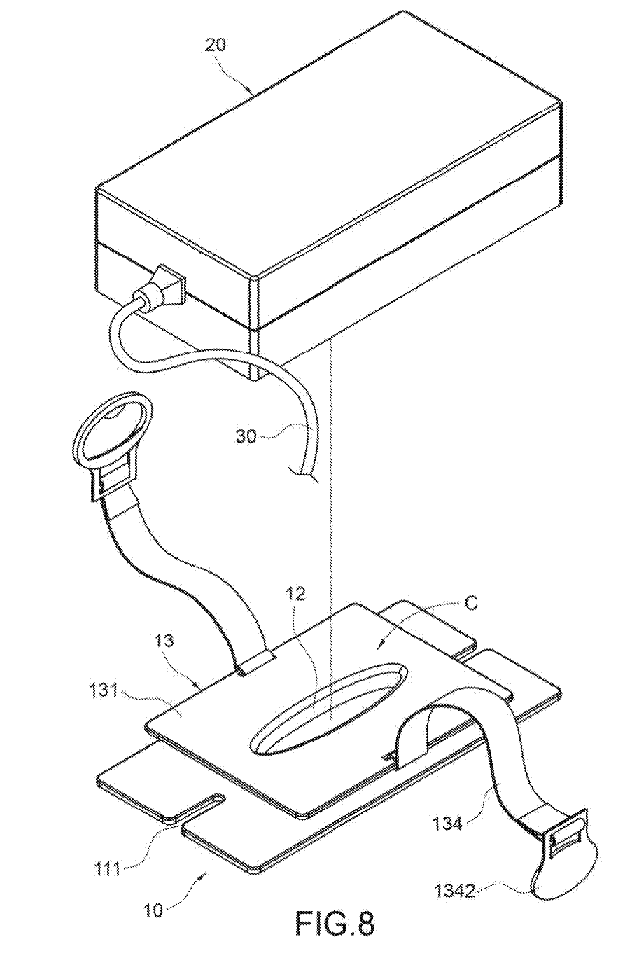

FIG. 8 is a schematic exploded view illustrating the connection between a main body of a power adapter and a supporting and wire-receiving mechanism according to a fifth embodiment of the present invention. The supporting and wire-receiving mechanism 10 of FIG. 8 is substantially identical to that of FIG. 7, except that no Velcro fasteners are attached on the two straps 134 but complementary buckles 1342 are formed on the two straps 134.

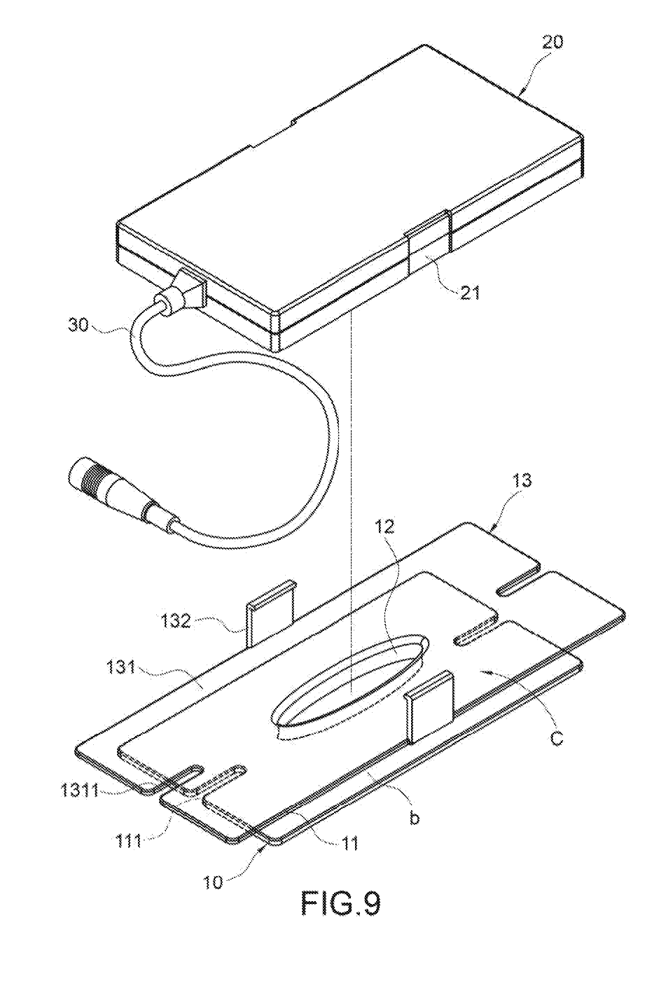

FIG. 9 is a schematic exploded view illustrating the connection between a main body of a power adapter and a supporting and wire-receiving mechanism according to a sixth embodiment of the present invention. The supporting and wire-receiving mechanism 10 of FIG. 9 is substantially identical to that of FIG. 1, except that the supporting plate 131 of the supporting member 13 further includes a wire-locking recess 1311 for locking the power wire 30. In a case that the power adapter is not in use, the terminal of the power wire 30 can be locked in the wire-locking recess 1311. As a consequence, the problem of loosening the power wire 30 that is encountered from the prior art will be effectively solved.

In the above embodiments, the present invention is illustrated by referring to a supporting and wire-receiving mechanism of a power adapter for use with a computer system. Nevertheless, the power adapter is not limited to be used in computer systems. In other words, the supporting and wire-receiving mechanism of the present invention can be applied to the power adapter for use in any electrical appliance.

From the above description, the supporting and wire-receiving mechanism of the present invention is capable of supporting the main body of the power adapter and receiving the wound power wire. In a case that the power adapter is in use, the supporting and wire-receiving mechanism of the present invention could facilitate managing the power cable. In a case that the power adapter is not in use, the terminal of the power wire can be locked in the wire-locking recess such that the possibility of loosening the power wire is minimized. Moreover, since the main body of the power adapter is supported on the supporting member of the supporting and wire-receiving mechanism, the power adapter is no longer in direct contact with the floor. Under this circumstance, the possibility of causing damage of the power adapter is minimized because the dust or water accumulated on the floor is no longer detrimental to the power adapter. As a consequence, the use of the supporting and wire-receiving mechanism can prolong the using life of the power adapter. According to the practical requirements, the main body of the power adapter can be supported on or detached from the supporting and wire-receiving mechanism, and thus the utilization flexibility is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A supporting and wire-receiving mechanism of a power adapter, said power adapter comprising a main body and a power wire, said supporting and wire-receiving mechanism comprising:
a supporting member having a supporting receptacle for accommodating said main body of said power adapter and supporting said power adapter;
a base arranged beside said supporting member; and
a wire-receiving member arranged between said base and said supporting member such that a wire-receiving receptacle is defined between said wire-receiving member, said base and said supporting member, wherein both ends of said wire-receiving member are respectively connected with said base and said supporting member, and said power wire is wound around said wire-receiving member and received in said wire-receiving receptacle.

2. The supporting and wire-receiving mechanism of a power adapter according to claim 1 wherein said base includes a wire-locking recess for locking said power wire.

3. The supporting and wire-receiving mechanism of a power adapter according to claim 1 wherein said supporting member further includes a wire-locking recess for locking said power wire.

4. The supporting and wire-receiving mechanism of a power adapter according to claim 1 wherein said supporting member includes an open-type supporting plate and a set of hooking elements, wherein said hooking elements are respectively protruded from bilateral sides of said supporting plate.

5. The supporting and wire-receiving mechanism of a power adapter according to claim 1 wherein said supporting member includes an open-type supporting plate and two straps, said two straps are respectively connected with bilateral sides of the supporting plate, and said two straps have Velcro fasteners on corresponding surfaces thereof.

6. The supporting and wire-receiving mechanism of a power adapter according to claim 1 wherein said supporting member includes an open-type supporting plate and two straps, said two straps are respectively connected with bilateral sides of the supporting plate, and said two straps have complementary buckles on corresponding surfaces thereof.

7. The supporting and wire-receiving mechanism of a power adapter according to claim 1 wherein said supporting member includes a hollow box with at least one entrance, and said main body of said power adapter is permitted to be accommodated within the hollow box through said entrance.

8. The supporting and wire-receiving mechanism of a power adapter according to claim 1 wherein said wire-receiving member has an elliptic cross-section.

9. The supporting and wire-receiving mechanism of a power adapter according to claim 1 wherein a wire-receiving receptacle is defined between an outer periphery of said wire-receiving member, said base and said supporting member, so that said power wire is permitted to be wound around said wire-receiving member and accommodated within said wire-receiving receptacle.

10. The supporting and wire-receiving mechanism of a power adapter according to claim 9 wherein said outer periphery of said wire-receiving member has a smaller dimension than an outer periphery of said base and an outer periphery of said supporting member.

11. A supporting and wire-receiving mechanism of a power adapter, said power adapter comprising a main body and a power wire, said supporting and wire-receiving mechanism comprising:
a supporting member having a first surface and a second surface opposed to said first surface, wherein a supporting receptacle is defined by said first surface of said supporting member for accommodating said main body of said power adapter, a wire-receiving member is disposed on a middle portion of said second surface of said supporting member, and an outer periphery of said wire-receiving member has a smaller dimension than an outer periphery of said supporting member; and
a base connected with said wire-receiving member for supporting said supporting said power adapter.

12. The supporting and wire-receiving mechanism of a power adapter according to claim 11 wherein said base includes a wire-locking recess for locking said power wire.

13. The supporting and wire-receiving mechanism of a power adapter according to claim 11 wherein said supporting member further includes a wire-locking recess for locking said power wire.

14. The supporting and wire-receiving mechanism of a power adapter according to claim 11 wherein said supporting member includes an open-type supporting plate and a set of hooking elements, wherein said hooking elements are respectively protruded from bilateral sides of said supporting plate.

15. The supporting and wire-receiving mechanism of a power adapter according to claim 11 wherein said supporting member includes an open-type supporting plate and two straps, said two straps are respectively connected with bilateral sides of the supporting plate, and said two straps have Velcro fasteners on corresponding surfaces thereof.

16. The supporting and wire-receiving mechanism of a power adapter according to claim 11 wherein said supporting member includes an open-type supporting plate and two straps, said two straps are respectively connected with bilateral sides of the supporting plate, and said two straps have complementary buckles on corresponding surfaces thereof.

17. The supporting and wire-receiving mechanism of a power adapter according to claim 11 wherein said supporting member includes a hollow box with at least one entrance, and said main body of said power adapter is permitted to be accommodated within the hollow box through said entrance.

18. The supporting and wire-receiving mechanism of a power adapter according to claim 11 wherein said wire-receiving member has an elliptic cross-section.

19. The supporting and wire-receiving mechanism of a power adapter according to claim 11 wherein a wire-receiving receptacle is defined between an outer periphery of said wire-receiving member, said base and said supporting member, so that said power wire is permitted to be wound around said wire-receiving member and accommodated within said wire-receiving receptacle.

20. The supporting and wire-receiving mechanism of a power adapter according to claim 11 wherein said outer periphery of said wire-receiving member has a smaller dimension than an outer periphery of said base.
